(19) United States
(12) Patent Application Publication
(10) Pub. No.: US 2007/0270177 A1
(43) Pub. Date: Nov. 22, 2007

(54) Field Device

(75) Inventors: Akira Nagashima, Musashino-shi (JP); Teruyoshi Minaki, Musashino-shi (JP); Satoru Kurosu, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/661,332

(22) PCT Filed: Aug. 24, 2005
(86) PCT No.: PCT/JP05/15358

§ 371 Date: Feb. 26, 2007

(30) Foreign Application Priority Data
Aug. 24, 2004 (JP) 2004-243706

(51) Int. Cl. H04L 1/00

(52) U.S. Cl. 455/550.1

(57) ABSTRACT

A field device to be installed at a process site is provided with a wireless terminal for connecting a removable radio communication unit to the field device.

### FIELD DEVICE

1. Technical Field

The present invention relates to a field device such as pressure/differential pressure transmitter, various types of flowmeters, thermometer and valve positioner that are distributed and installed in a plant, a factory, etc., and relates particularly to a field device in which adding of a wireless function or function change can be easily performed.

2. Background Art

Field devices are distributed and installed in a plant, a factory, etc. The field devices are pressure/differential pressure transmitter, various types of flowmeters, thermometer, valve positioner, etc.

The field device is connected to a control computer system by a two-wire signal line, etc., to generate power from a signal of 4-20 mA that is transmitted through the transmission line, and transmits collected data to the control computer system.

There is also a field device incorporating a wireless section, and such a field device transmits detected and collected data to the control computer system.

JP-T-10-508129, JP-A-2003-134030, JP-A-2003-134261, U.S. Pat. No. 5,682,476 and U.S. Pat. No. 6,236,334 are referred to as related arts.

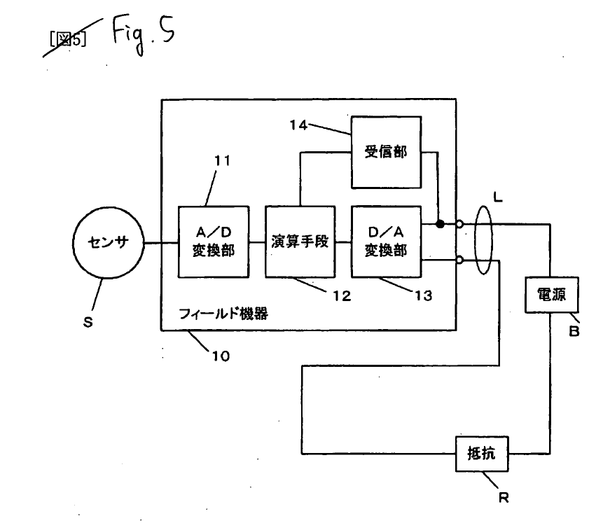

FIG. 4 is a diagram showing an example of the overall of the system, wherein field devices as related arts are connected. In FIG. 4, a valve V and a positioner P, a flowmeter F, and a differential pressure transmitter D including an orifice o are connected, as various types of field devices, to a pipe Q in which various types of fluids flow.

The individual field devices P, F and D, which are connected to a control unit FC via an input/output unit I/O by respective two-wire signal transmission lines L1, L2, L3, are supplied with power by a signal of 4-20 mA, and transmit detected physical quantity signals (flow amount signals, pressure signals, etc.).

Further, a system has been proposed wherein the individual field devices P,F,D incorporate a radio communication section to convert detected physical quantity signals into radio signals and to transmit them to a radio station (not shown).

A system has been also proposed wherein a diagnosis tool MMI is arranged in an upper level or a diagnosis sensor is provided for each of the existing field devices, in order to diagnose the individual field devices, and in addition to the above two-wire signal transmission line, another signal line is provided for diagnosing the field devices.

The general configuration blocks of such a field device are shown in FIG. 5.

In FIG. 5, a field device 10 includes a sensor S that detects the physical quantity of each type of fluid, or the like, and has: an A/D converter 11 which performs A/D conversion of a value received from the sensor S; an operation section 12 such as a CPU which performs various computation processes for the value from the A/D converter 11, and a memory; a D/A converter 13 which performs D/A conversion of the computation results obtained by the operation section 12 and outputs the results to a two-wire signal transmission line L; and a receiving section 14 which receives various types of instruction signals and setting signals or the like from the two-wire signal transmission lie L, and transmits them to the operation section 12.

It should be noted that the input/output unit I/O shown in FIG. 4 is actually a block shown in FIG. 5, that includes a power source B for supplying power to the two-wire transmission line L, a resistor R and an A/D converter (not shown).

With this arrangement, various computations are performed on the physical quantity detected by the sensor S, and the result is output as a 4-20 mA current signal to the two-wire transmission line L.

The input/output unit I/O receives this 4-20 mA current signal, and outputs the signal to the control unit (controller) FC in an upper level or the diagnosis tool MMI.

### DISCLOSURE OF THE INVENTION

### Problems that the Invention is to Solve

From the viewpoint of a diagnosis of a field device, development of a redundancy of signal transmission, etc., there are many demands for a field device having a wireless function. However, when multiple field devices having a wireless function are newly provided, it is difficult to cope with demands, for example, to improve the functions of existing field devices that do not have a wireless function, and to change or update the specifications and standards for a signal line, a bus, etc., to which the field devices are connected.

One object of the present invention is to provide a field device in which the adding of a wireless function or the change of the function can be easily performed.

### Means for Solving the Problems

The present invention provides a field device to be installed at a process site, the field device comprising:

a wireless terminal for connecting a removable radio communication unit to the field device.

The field device comprising:

an operation section; and

an output section,

wherein the wireless terminal includes at least one of a first wireless terminal arranged for the operation section or a second output terminal arranged for the output section.

In the field device, the radio communication unit includes:

a receiving section for receiving program data; and

a rewritable memory for storing the program data.

In the field device, the radio communication unit includes:

a path setting section for determining a transmission destination of a radio signal.

In the field device, the radio communication unit includes:

a path setting section for determining a transmission destination of a radio signal that is received from another field device.

### ADVANTAGES OF THE INVENTION

According to the field device, since the radio communication unit is connected to the wireless terminal of the field device, and an output signal of the field device can be transmitted wirelessly, a diagnosis and various data processes of the field device can be easily performed.

The radio communication unit is a module, which is removable from the wireless terminal. Therefore, when the specifications, and the standards for a radio signal to be transmitted or received are changed or updated, the radio communication unit can be removed and modified, and again mounted to the wireless terminal. For example, in a case where the transmission/reception of a field bus signal is performed by using a radio signal, even when the specifications and the standards, etc., for the field bus signal are changed or updated, the radio communication unit need only be removed, and a radio communication unit conforming to this change or update need only be mounted. Therefore, the change or the update can be easily coped with.

Furthermore, since the radio communication unit includes a rewritable memory, program data conforming to the change in standards of a radio signal to be transmitted or received can be downloaded by using a radio signal.

By the radio path setting performed by the path setting section of the radio communication unit, the transmission destination of a radio signal corresponding to the output signal, or the transmission destination of an externally received radio signal can be set not only to a ordinary radio station, but also to a radio communication unit that is connected to another field device. Therefore, the radio communication unit can be utilized as a radio relay point.

As described above, since the wireless terminal is mounted on the field device and the radio communication unit formed by a module is removable, adding a wireless function or changing the function can be easily performed for multiple existing field devices that are installed in a single system.

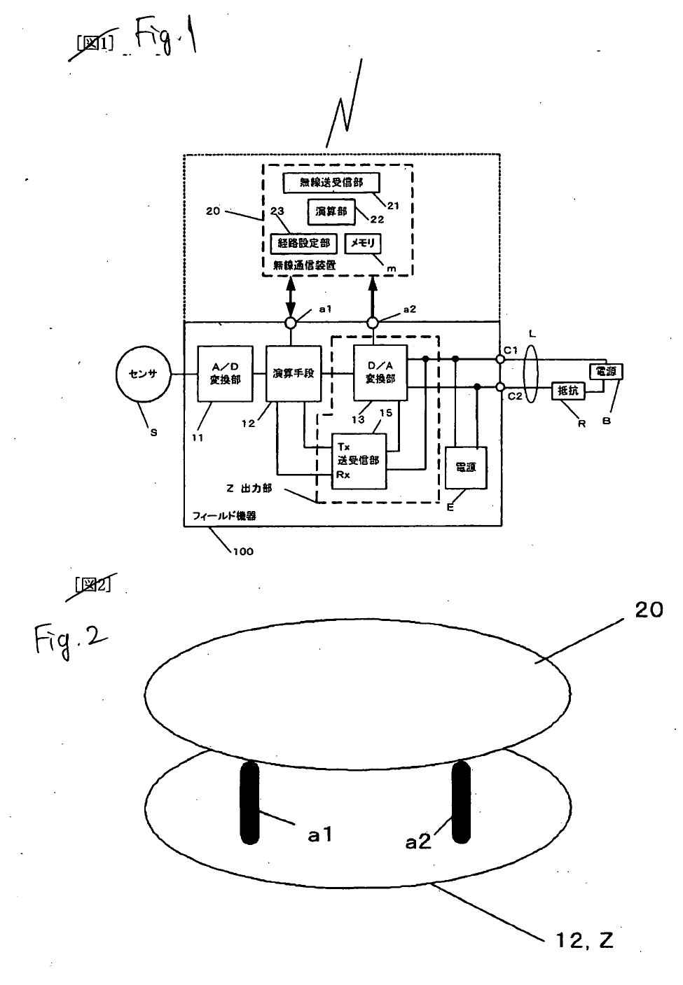

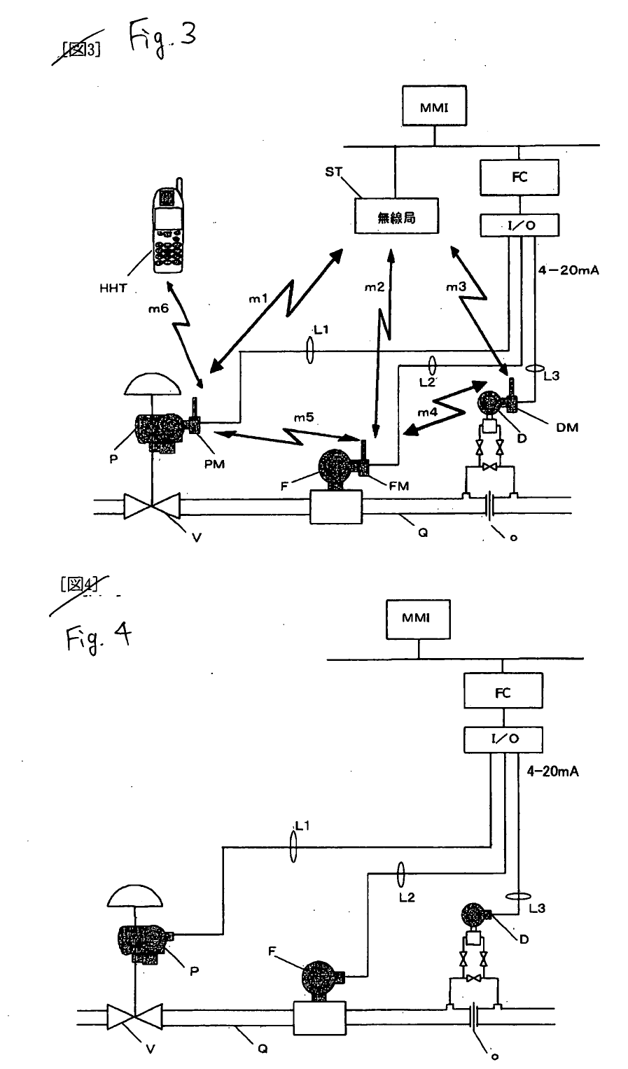

### BRIEF DESCRIPTION OF THE DRAWINGS

[FIG. 1] is a diagram showing an overall configuration of a field device according to the present invention.

[FIG. 2] is a diagram showing the field device of the present invention as a module arrangement.

[FIG. 3] is a diagram of an overall of a system employing the field device according to the present invention.

[FIG. 4] is a diagram of an overall of a system employing a field device as related art.

[FIG. 5] is a configuration block diagram of a field device as related art.

### DESCRIPTION OF REFERENCE NUMERALS AND SIGNS

100: field device
11: A/D converter
12: operation section
13: D/A converter
15: transmitting/receiving section
S: sensor
20: radio communication unit
21: radio transmitting/receiving section
22: operation section
23: path setting section
L, L1, L2, L3: two-wire signal line

### BEST MODE FOR CARRYING OUT THE INVENTION

An embodiment according to a field device of the present invention will now be described in detail while referring to drawings. FIG. 1 is a block diagram showing a configuration of the field device according to the present invention.

As shown in FIG. 1, the field device 100 in the present embodiment includes a sensor S, and is coupled with a two-wire signal line L at junction points C1, C2. Further, in the field device 100, since components denoted by the same reference symbols as in the field device 10 shown in FIG. 5 have the same functions, the detailed explanation is omitted.

It should be noted that an output section Z has a D/A converter 13 and a transmitting/receiving section 15. A signal from an operation section 12 is transmitted via the transmitting/receiving section 15 and the D/A converter 13 to the two-wire transmission signal line L, and a signal from the two-wire signal line L is received by the transmitting/receiving section 15 and is transferred to the operation section 12 to be processed.

Further, a power source E is a block that supplies power to the individual components of the field device 100.

In the field device 100 of the present embodiment, a wireless terminal (a1 or a2) is installed in an internal function module that performs transmission/reception with the outside. When a radio communication unit 20 having a module configuration is externally connected to the wireless terminal (a1 or a2), the radio communication unit 20 can be attached to the field device 100.

The function module described above is, for example, the operation section 12 or the output section Z, and while referring to FIG. 1, the wireless terminal a1 is provided to the operation section 12, while the output terminal a2 is provided to the output section Z. The radio communication unit 20 is arbitrarily mounted to the wireless terminal a1, a2.

The radio communication unit 20 is a module that includes a radio transmitting/receiving section 21, an operation section 22 and a rewritable memory m, and that is removable from the terminals a1, a2 of the field device 100.

The above-described field terminal 100 operates as follows.

The A/D converter 11 performs an A/D conversion on a physical quantity signal such as a temperature, a flow amount or a pressure from a sensor S, the operation section 12 performs a computation process on the resultant signal, and the D/A converter 13 and the transmitting/receiving section 15 transmit the signal as 4-20 mA current signal through the terminals C1, C2 to the two-wire signal transmission line L.

Further, a signal received from the two-wire signal line L is supplied to the power source E, and is provided as power to the individual components in the field device 100.

Furthermore, when a hand-held terminal, etc., is installed with respect to the two-wire signal line L, the transmitting/receiving section 15 receives a set up change signal, etc., from the hand-held terminal, and provides this setup change signal, etc., to the operation section 12.

Under this condition, in a case where the field device 100 is to be updated to a device conforming to a radio signal, the radio communication unit 20 as a module is externally arranged, as needed, at the wireless terminal a1 of the operation section 12 or the output terminal a2 of the output section z.

With this arrangement, the field device 100 can be updated to a radio-compatible field device, and an output signal from the operation section 12 or an output signal from the D/A converter 13 is externally transmitted as a radio signal by the radio transmitting/receiving section 21 in the radio communication unit 20.

At this time, the field device 100 can transmit the signal from the radio communication unit 20 as the output signal of the field device 100 at the same time with transmitting the signal to the two-wire signal line L, or can transmit only the radio signal from the radio communication unit as the output signal of the field device 100.

Additionally, in a case where a setup change signal, etc., is received as a radio signal from a hand-held terminal or an upper level side, the radio communication unit 20 receives the signal and provides the signal from the radio transmitting/receiving section 21 and the operating section 22 having a CPU, etc., to the operation section 12 as a setup change signal.

Since the radio communication unit 20 includes the operation section 22 and the memory m, a radio protocol received by the radio communication unit 20 can be converted into the mode of a setup change signal corresponding to the operation section 12.

In the memory m, a radio protocol signal to be received, a signal mode capable of being processed by the operation section 12, etc., are stored, for example, in a table format.

Further, in a case where the function of the entire system in which the field device 100 is installed is upgraded, or where the specifications and standards of a radio signal to be transmitted and received are changed, only the radio communication unit 20 corresponding to this change need be removed directly, and a new radio communication module need be mounted at the terminals a1, a2. Thus, this setting update can be immediately coped with.

Or, since the memory m is rewritable, even when the specifications and the standards of a radio signal to be transmitted or received are changed or updated, the radio protocol and the table format of a signal that the operation section 12 can process need only be rewritten by a downloading method. Once the radio communication unit 20 has been installed as a module, updating can thereinafter be coped with.

For example, in a case where the radio communication unit 20 of the field device 100 performs transmission/reception of a field bus signal instead of the two-wire signal line L, and even when the signal specifications and standards for the field bus signal are newly added or updated, the radio communication unit 20 can be removed as a module, or updating of a setting can be downloaded wirelessly.

Specifically, as shown in FIG. 2, on a circuit board (e.g., a circular print board) including the operation section 12 and the output section Z, the radio communication unit 20 is also set up as a circuit board so as to be removable from the terminal a1 and the terminal a2. In this manner, the module configuration of the radio communication unit 20 can be obtained.

Referring again to FIG. 1, the radio communication unit 20 may also internally include a path setting section 23 which designates a radio path for transferring a radio signal to an upper level radio station mutually through the radio communication units 20 that are installed in a plurality of the field devices 100, as will be described below.

Specifically, the path setting section 23 is a circuit section that sets an algorithm for designating an upper level radio station to be a transmission destination of a radio signal of the radio communication unit 20, or for designating, as a relay point, a radio communication unit 20 installed in the other field device 100. Further, the path setting section 23 is a circuit section that sets and algorithm for, when the radio communication unit 20 to be the relay point suffers a failure or an abnormality, designating the other radio communication unit 20.

That is, in a case where a failure occurs at a destination to which a radio signal is to be transmitted from the radio communication unit 20, i.e., in a case where an abnormality has occurred, a radio path is designated to change the destination of the transmission of a radio signal or to transfer the received radio signal to a radio communication unit that is attached to the other field device and serves simply as a radio signal relay point.

FIG. 3 shows an example of an overall of the system that includes the field devices to which these radio communication units are additionally provided. In this example, radio communication units PM, FM, DM are externally connected and attached as modules respectively to the field devices P, F, D, in the entire the system of the related art shown in FIG. 4.

With this arrangement, as radio signals m1, m2, m3, the individual field devices P, F, D can transmit signals output to the two-wire signal transmission lines L1, L2, L3 to a radio station ST through the radio communication units PM, FM, DM. Or, communication may be performed by a hand-held terminal HHT of a radio system and a radio signal m6.

Further, since a radio wave may not reach the radio station ST depending on the installation situations of the field devices P, F, D or the radio communication units PM, FM, DM, a radio path may be designated so that, e.g., the radio signal m4 is transmitted from the radio communication unit DM to the radio communication unit FM, the radio signal m5 is transmitted from the radio communication unit FM to the radio communication unit PM by using the radio communication unit FM as a relay point, and the radio signal m1 is transmitted from the radio communication unit PM to the radio station ST.

Or, a path that is the opposite of the above-described path may be designated. Furthermore, when a radio communication unit serving as a relay point suffers a failure, the radio path may be altered to change the relay point.

According to the present invention, in the above-described manner, radio transmission and radio reception of a signal associated to the field device, and setup change by a radio signal, etc., can be performed.

The present invention is based on Japanese Patent Application (No. 2004-243706), filed on Aug. 24, 2004, and the contents thereof are incorporated herein as a reference.

[FIG. 1]
B: POWER SOURCE
E: POWER SOURCE
R: RESISTOR
S: SENSOR
Z: OUTPUT SECTION
m: MEMORY
11: A/D CONVERTER
12: OPERATION SECTION
13: D/A CONVERTER
15: TRANSMITTING/RECEIVING SECTION
20: RADIO COMMUNICATION UNIT
21: RADIO TRANSMITTING/RECEIVING SECTION
22: OPERATION SECTION
23: PATH SETTING SECTION
100: FIELD DEVICE

[FIG. 3]
ST: RADIO STATION

[FIG. 5]
B: POWER SOURCE
R: RESISTOR
S: SENSOR
10: FIELD DEVICE
11: A/D CONVERTER
12: OPERATION SECTION
13: D/A CONVERTER
14: RECEIVING SECTION

1. A field device to be installed at a process site, the field device comprising:
a wireless terminal for connecting a removable radio communication unit to the field device.

2. The field device according to claim 1, comprising:
an operation section; and
an output section,
wherein the wireless terminal includes at least one of a first wireless terminal arranged for the operation section or a second output terminal arranged for the output section.

3. The field device according to claim 1, wherein the radio communication unit includes:
a receiving section for receiving program data; and
a rewritable memory for storing the program data.

4. The field device according to claim 1, wherein the radio communication unit includes:
a path setting section for determining a transmission destination of a radio signal.

5. The field device according to claim 1, wherein the radio communication unit includes:
a path setting section for determining a transmission destination of a radio signal that is received from another field device.
